(19) United States
(12) Patent Application Publication
(10) Pub. No.: US 2007/0228963 A1
(43) Pub. Date: Oct. 4, 2007

(54) Plasma display panel

(76) Inventor: Seong-Hun Choo, Suwon-si (KR)

Correspondence Address: Robert E. Bushnell;Suite 300, 1522 K Street, N.W., Washington, DC, 20005, US

(21) Appl. No.: 11/724,273

(22) Filed: Mar. 15, 2007

(30) Foreign Application Priority Data
Mar. 29, 2006 (KR) 10-2006-0028286

(51) Int. Cl. H01J 17/49

(52) U.S. Cl. 313/582

(57) ABSTRACT

A plasma display panel capable of stabilizing a discharge characteristic by integrating discharge cells with a high density and efficiently exhausting the plasma display panel is provided. The plasma display panel is constructed with: first and second substrates facing each other; barrier ribs disposed between the first and second substrates to define discharge cells; address electrodes extending in a first direction and corresponding to the discharge cells; and first and second electrodes extending in a second direction that crosses the first direction and corresponding to the discharge cells. The red, green, and blue discharge cells among the discharge cells are disposed in a triangular shape. Exhaust paths are formed between neighboring discharge cells.

### CLAIMS OF PRIORITY

This application makes reference to, incorporates the same herein, and claims all benefits accruing under 35 U.S.C. §119 from an application for PLASMA DISPLAY PANEL earlier filed in the Korean Intellectual Property Office on 29 Mar. 2006 and there duly assigned Serial No. 10-2006-0028286.

### BACKGROUND OF THE INVENTION

1. Field of the Invention

The present invention relates to a plasma display panel, and more particularly, to a plasma display panel capable of stabilizing a discharge characteristic by integrating discharge cells with a high density in the plasma display panel and efficiently performing an exhausting process in the plasma display panel.

2. Description of the Related Art

In general, a plasma display panel is an element for displaying images by using visible light of red, green, and blue generated by exciting a florescent material by using vacuum ultra-violet (VUV) rays emitted from plasma obtained through gas discharge.

For example, in an alternating current (AC) type plasma display panel, address electrodes are formed on a rear substrate and are covered with a dielectric layer. Barrier ribs are disposed between neighboring address electrodes. The barrier ribs have a stripe shape. Phosphor layers of red, green, and blue are formed on the barrier ribs. Display electrodes including a pair of sustain and scan electrodes are formed in a direction that crosses the address electrodes on a front substrate that faces the rear substrate and are covered with a dielectric layer and an MgO passivation film. The discharge cells are formed at positions where a pair of the address electrodes on the rear substrate cross a pair of the display electrodes on the front substrate. In the plasma display panel, more than millions of discharge cells are arranged in a matrix shape.

A memory characteristic is used to drive the plasma display panel. More specifically, a voltage, which is greater than a certain voltage required for inducing discharge, is applied between a pair of the sustain and scan electrodes. The certain voltage represents a firing voltage (Vf). When a scan voltage and an address voltage are respectively applied to the scan and address electrodes, plasma is generated in the discharge cells. Electrons and ions of the plasma move toward electrodes having polarities opposite to the electrons and the ions.

On the other hand, since each electrode of the plasma display panel is covered with the dielectric layer, most of the moved space charges are accumulated in the dielectric layer having a polarity opposite to the space charges. Finally, net space charge between the scan and address electrodes becomes less than the applied address voltage Va. Accordingly discharge weakens. Address discharge disappears. At this time, a relatively small amount of electrons are accumulated in the sustain electrode while a relatively large amount of electrons are accumulated in the scan electrodes. The charges accumulated in the dielectric layer that covers the sustain and scan electrodes are referred to as wall charges. A voltage between the sustain and scan electrodes caused by the wall charges is referred to as a wall voltage Vw.

Subsequently, when a discharge sustain voltage Vs is applied to the sustain and scan electrodes, in a case where a value (Vs+Vw) obtained by adding the discharge sustain voltage Vs to the wall voltage Vw is greater than the firing voltage Vf, sustain discharge is carried out in the discharge cells. The VUV rays generated at this time excite the corresponding phosphor material. The excited phosphor material emits the visible light through the transparent front substrate.

When there is no address discharge between the scan and address electrodes (that is, when the address voltage Va is not applied), however, the wall charges are not accumulated between the sustain and scan electrodes. Finally, there are no wall charges between the sustain and scan electrodes. At this time, only a discharge sustain voltage Vs applied to the sustain and scan electrodes is maintained in the discharge cells. Since the discharge sustain voltage is less than the firing voltage Vf, discharge cannot be carried out in a space filled with a gas between the sustain and scan electrodes.

In a process of exhausting and sealing the plasma display panel among processes of manufacturing the plasma display panel, it is possible to carry out the gas discharge by exhausting the space between the front and rear substrates and filling the space with a discharge gas.

On the other hand, the plasma display panel is formed by integrating the discharge cells of red, green, and blue with a high density so as to obtain a super extended resolution (for example, a resolution of 1920*1080).

For example, there is a plasma display panel in which discharge cells are integrated with a high density by forming the discharge cells in a hexagonal shape and disposing another hexagonal discharge cell at each side of a hexagonal discharge cell.

Since the discharge cells are integrated into the plasma display panel with a high density, however, impurities undesirably remain between the discharge cells. The impurities cause discharge irregularity and local luminance non-uniformity.

### SUMMARY OF THE INVENTION

It is therefore an object of the present invention to provide an improved plasma display panel.

It is another object to provide a plasma display panel capable of stabilizing a discharge characteristics.

According to an aspect of the present invention, there is provided a plasma display panel comprising: a first substrate; a second substrate facing the first substrate; barrier ribs disposed between the first and second substrates to define discharge cells; address electrodes extending in a first direction and corresponding to the discharge cells; and first and second electrodes extending in a second direction that crosses the first direction and corresponding to the discharge cells. The red, green, and blue discharge cells among the discharge cells may be disposed in a triangular shape. Exhaust paths may be formed between neighboring discharge cells.

In the above aspect of the present invention, the discharge cells may have a rhombic shape with diagonals in the first and second directions.

In addition, the barrier ribs may define discharge cells that are separate from one another along both the x-axis and the y-axis directions.

In addition, the exhaust paths may be formed in third and fourth directions. Both of the third and fourth directions cross the first and second directions. The third direction may be orthogonal to the fourth direction.

In addition, the barrier ribs of the discharge cells disposed along the second direction may be connected to one another, and the barrier ribs of the discharge cells disposed along the first direction may be spaced apart from one another to form the exhaust paths between the barrier ribs.

In addition, the barrier ribs of the discharge cells disposed along the first direction maybe connected to one another, and the barrier ribs of the discharge cells disposed along the second direction may be spaced apart from one another to form the exhaust paths between the barrier ribs.

In addition, a ratio of a diagonal length of the discharge cell in the first direction to a diagonal length the discharge cell in the second direction may range from approximately 1 to approximately 1.5.

In addition, a width of the barrier ribs may be smaller than a width of the exhaust paths.

In addition, the first and second electrodes may be covered with a dielectric layer, and the dielectric layer and the barrier ribs may be in a subtractive color mixture relation.

In addition, the dielectric layer and the barrier ribs may be in a complementary color relation.

In addition, the dielectric layer may be colored with blue, and the barrier ribs may be colored with red or brown.

In addition, the barrier ribs may include: a pair of first barrier ribs that extend in a third direction crossing the first and second directions, spaced apart from one another and corresponding to each discharge cell in a fourth direction which is perpendicular to the third direction; and a pair of second barrier ribs that extend in the fourth direction, spaced apart from one another and corresponding to each discharge cell in the third direction.

In addition, the pair of the first barrier ribs and the pair of the second barrier ribs may form discharge cells that have a rhombic shape and that are separate from one another in the first and second directions.

In addition, the pair of the first barrier ribs and the pair of the second barrier ribs of the discharge cells disposed along the second direction may be connected to each other or cross each other. The pair of the first barrier ribs and the pair of the second barrier ribs of the discharge cells disposed along the first direction are spaced apart from each other to form the exhaust paths. And the discharge cells have a rhombic shape.

In addition, the exhaust paths may have a zigzag shape along the third and fourth directions alternately.

In addition, the pair of the first barrier ribs and the pair of the second barrier ribs of the discharge cells disposed along the first direction maybe connected to each other or cross each other. The pair of the first barrier ribs and the pair of the second barrier ribs of the discharge cells disposed along the second direction are spaced apart from each other to form the exhaust paths. And the discharge cells have a rhombic shape.

In addition, the exhaust paths may have a zigzag shape along the third and fourth directions alternately.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view schematically illustrating a plasma display panel constructed as a first embodiment according to the principles of the present invention by exploding the plasma display panel;

FIG. 2 is a cross sectional view taken along line II-II′ of FIG. 1;

FIG. 3 is a top plan view illustrating an arrangement of barrier ribs and discharge cells of FIG. 1;

FIG. 4 is a top plan view illustrating an arrangement of barrier ribs and discharge cells according to a second embodiment of the principles of the present invention; and

FIG. 5 is a top plan view illustrating an arrangement of barrier ribs and discharge cells according to a third embodiment of the principles of the present invention.

### DETAILED DESCRIPTION OF THE INVENTION

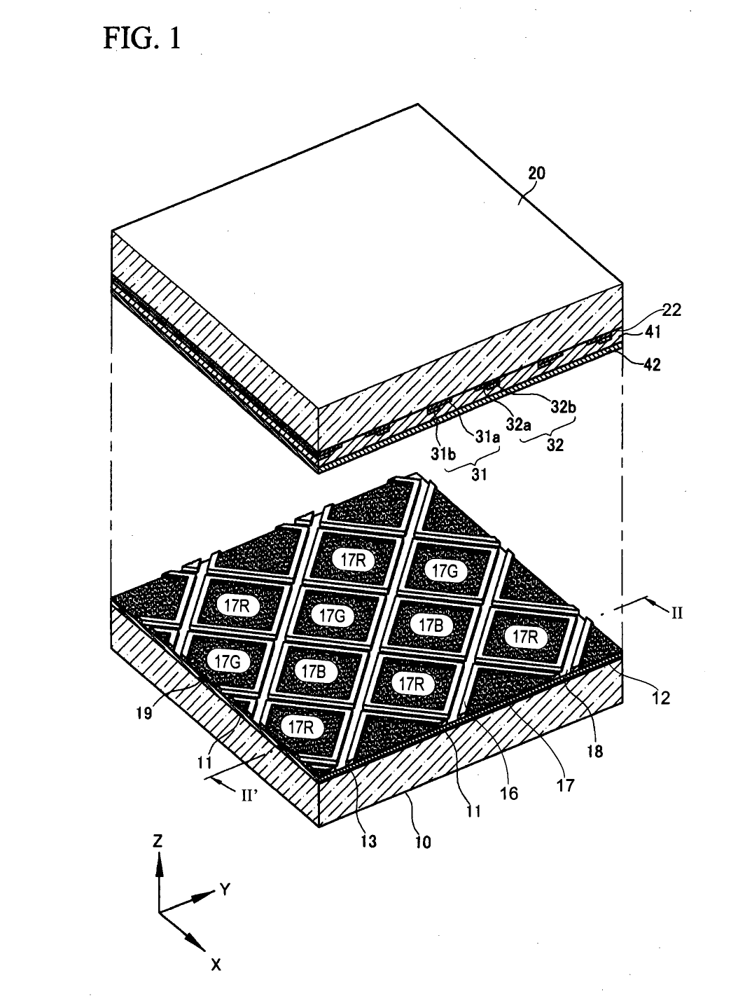

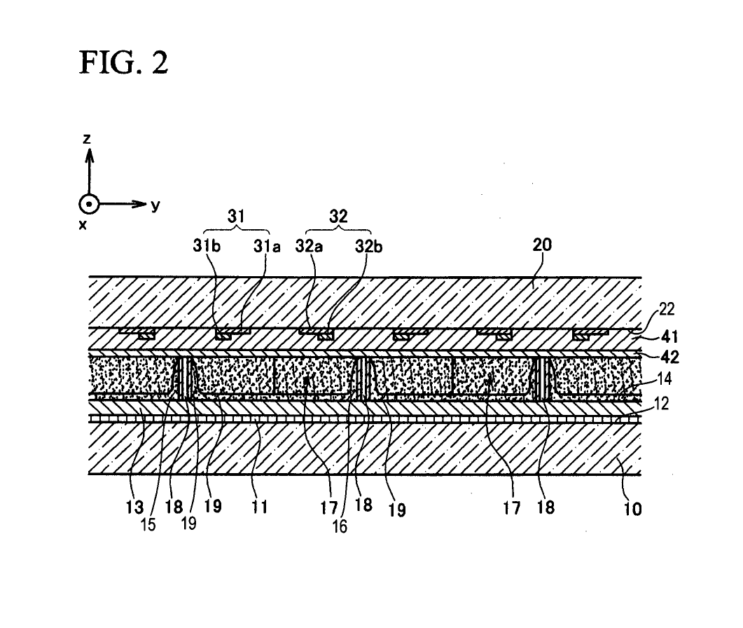

FIG. 1 is a perspective view schematically illustrating a plasma display panel according to a first embodiment of the present invention by exploding the plasma display panel. FIG. 2 is a cross sectional view taken along line II-II′ of FIG. 1.

Referring to FIGS. 1 and 2, the plasma display panel according to the first embodiment of the principles of the present invention is constructed with a first substrate 10 (hereinafter, referred to as “rear substrate”) and a second substrate 20 (hereinafter, referred to as “front substrate”) which are sealed to face each other with a certain gap, and a barrier rib 16 which is disposed between first and second substrates 10 and 20.

Barrier rib 16 is formed with a certain height to define a plurality of discharge cells 17 between rear and front substrates 10 and 20.

Discharge cells 17 are filled with a discharge gas (for example, a gas mixture including neon (Ne) and xenon (Xe)) so as to generate vacuum ultraviolet rays through gas discharge. Each discharge cell 17 includes a phosphor layer 19 which emits visible light by absorbing the vacuum ultraviolet rays.

The plasma display panel according to the embodiment of the present invention includes address electrodes 11, first electrodes 31 (hereinafter, referred to as “sustain electrodes”) and second electrodes 32 (hereinafter, referred to as “scan electrodes”), that correspond to discharge cells 17 between rear and front substrates 10 and 20.

For example, each address electrode 11 extends along a first direction (y-axis direction of FIGS. 1 and 2) on an inner surface 12 of rear substrate 10 to correspond to neighboring discharge cells 17 in the y-axis direction. In addition, a plurality of address electrodes 11 are disposed in parallel with each other along a second direction (x-axis direction of FIGS. 1 and 2) which crosses the y-axis direction to correspond to neighboring discharge cells 17 in the x-axis direction.

Address electrodes 11 are covered with a dielectric layer 13 which also covers the inner surface of rear substrate 10. Dielectric layer 13 prevents damages of address electrodes 11 by preventing positive ions or electrons from directly colliding against address electrodes 11. Dielectric layer 13 generates wall charges. The wall charges are accumulated in dielectric layer 13. Since address electrodes 11 are disposed on rear substrate 10, address electrodes 11 do not block visible light which is irradiated toward the front side. Accordingly, address electrode 11 maybe made from an opaque material such as a metal that has high electrical conductivity.

Barrier rib 16 is disposed on dielectric layer 13 to define discharge cells 17. Discharge cells 17 are classified into red (R), green (G), and blue (B) discharge cells 17R, 17G, and 17B, which are three sub pixels. The three sub pixels constitute one pixel.

On the other hand, dielectric layer 13 and barrier rib 16 may be in a subtractive color mixture relation, and more specifically in a complementary color relation. In color science, two colors are complementary if, when mixed, they produce a shade of grey. For example, dielectric layer 13 may be colored with a blue based color and barrier rib 16 may be colored with a red or brown based color. In this case, a bright room contrast can be improved as compared with the case where dielectric layer 16 is transparent, and barrier rib 16 is white.

Barrier rib 16 is formed so that red, green, and blue discharge cells 17R, 17G, and 17B are arranged in a triangular shape. Exhaust paths 18 may be formed between neighboring discharge cells among red, green, and blue discharge cells 17R, 17G, or 17B. Therefore, during the process of manufacturing the plasma display channel and before rear and front substrates 10 and 20 are sealed, at least one external vacuum system (not shown) is connected with exhaust paths 18 to create a vacuum by exhausting the space between rear and front substrates 10 and 20 and the exhaust gas is conducted through exhaust paths 18. After this exhausting process, rear and front substrates 10 and 20 is sealed and exhaust paths 18 are sealed shut along the periphery of the plasma display panel.

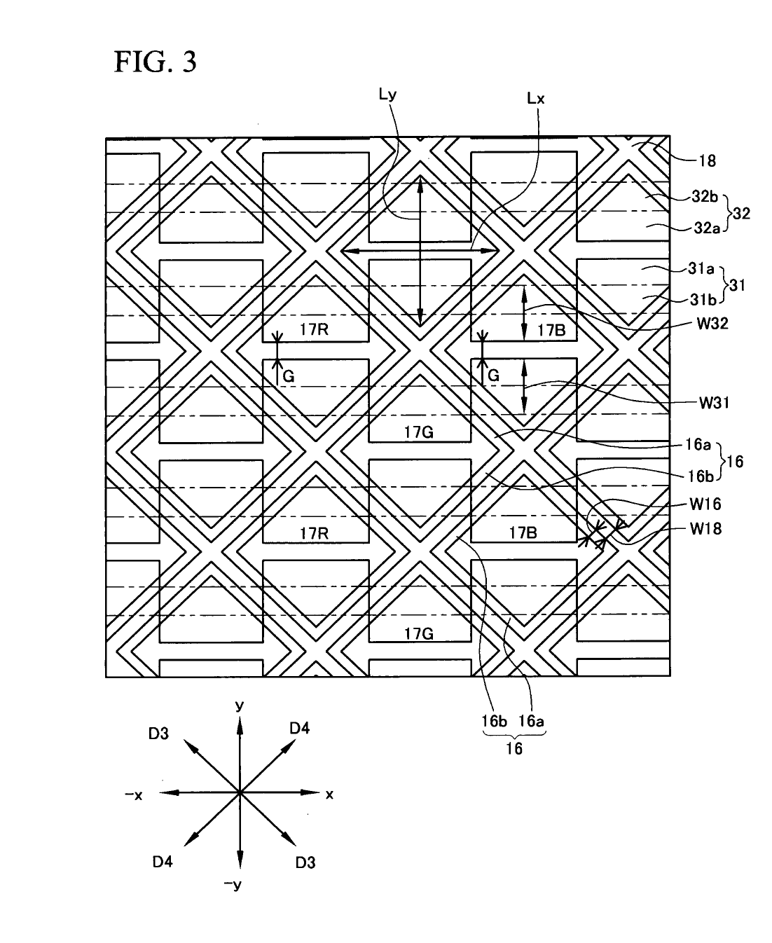

Referring to FIG. 3, the discharge cells can be integrated with a high density on rear substrate 10 by arranging red, green, and blue discharge cells 17R, 17G, and 17B which are the sub pixels into a triangular shape, as compared with a structure (not shown) in which the red, green, and blue discharge cells are repeatedly arranged along one direction within the same area. Here, the triangular arrangement structure represents a structure in which the respective centers of red, green, and blue discharge cells 17R, 17G, and 17B form a triangle.

Accordingly, barrier rib 16 defines each of red, green, and blue discharge cells 17R, 17G, and 17B in a rhombic shape. Specifically, each of red, green, and blue discharge cells 17R, 17G, and 17B has two vertices aligned in the y-axis direction and two vertices aligned in the x-axis direction. In addition, discharge cells 17R, 17G, and 17B defined by barrier rib 16 are separate and independent along the y-axis direction and the x-axis direction. In other words, discharge cells 17R, 17G, and 17B defined by barrier rib 16 are spaced apart from each other along both the y-axis direction and the x-axis direction such that exhaust paths can be formed between either two of the discharge cells selected from discharge cells 17R, 17G, and 17B.

Red, green, and blue discharge cells 17R, 17G, and 17B having a rhombic shape are separately arranged in a triangular shape. Accordingly, exhaust paths 18, which are formed between neighboring charge cells among red, green, and blue discharge cells 17R, 17G, or 17B, are formed in third and fourth directions D3 and D4 that are rotated by a certain angle with respect to the y-axis and x-axis directions. Third direction D3 is a direction located between (−)x and y directions and between (−)y and x directions. Fourth direction D4 is a direction located between x and y directions and between (−)y and (−)x directions.

Exhaust paths 18 are formed in third and fourth directions D3 and D4, and discharge cells 17 are disposed between exhaust paths 18. Therefore, impurities, which are remained in the plasma display panel when the plasma display panel is exhausted and sealed, can be minimized to improve the exhaust characteristic.

For example, barrier ribs 16 defining the discharge cells have a certain width W16. Exhaust paths 18 have a width W18 larger than that W16 of barrier ribs 16. In order to improve the exhaust characteristic, exhaust paths 18 may have a width as large as possible within an allowable range in which discharge cells 17 can be integrated.

As described above, when the first and second directions are the y-axis and x-axis directions which are orthogonal to each other, third and fourth directions D3 and D4 are orthogonal to each other. At this time, the shape of discharge cells 17 may be a square. The first and second directions are not limited to the y-axis and x-axis directions. When the shape of discharge cells 17 is not the square, the third and fourth directions cross each other by an angle that is not a right angle.

More specifically, barrier ribs 16 includes a pair of first barrier ribs 16a, which extend in third direction D3, and a pair of second barrier ribs 16b, which extend in fourth direction D4.

The pair of first barrier ribs 16a extend in third direction D3. The pair of first barrier ribs 16a are spaced apart from each other by a distance corresponding to the length of a single discharge cell 17 along fourth direction D4. The pair of second barrier ribs 16b extend in fourth direction D4. The pair of second barrier ribs 16b are spaced apart from each other by a distance corresponding to the length of a single discharge cell 17 along third direction D3.

The pair of first barrier ribs 16a and the pair of second barrier ribs 16b define a separate and single discharge cell 17. Accordingly, the number of the pair first barrier ribs 16a corresponds to the number of discharge cells 17. In addition, the number of the pair of second barrier ribs 16b corresponds to the number of discharge cells 17.

Accordingly, the pair of first barrier ribs 16a and the pair of second barrier ribs 16b define a single discharge cell 17 in a rhombic shape. Discharge cells 17 are separately and independently arranged in the x-axis and y-axis directions.

On the other hand, in each discharge cell 17, a ratio of a diagonal length Ly in the y-axis direction to a diagonal length Lx in the x-axis direction may range from approximately 1 to approximately 1.5.

When the ratio (Ly/Lx) of diagonal length Ly in the y-axis direction to diagonal length Lx in the x-axis direction of discharge cell 17 is less than 1, diagonal length Lx in the x-axis direction is excessively greater than diagonal length Ly in the y-axis direction. Accordingly, it is difficult to obtain a suitable resolution in the x-axis direction.

In addition, when the ratio (Ly/Lx) of diagonal length Ly in the y-axis direction to diagonal length Lx in the x-axis direction of discharge cell 17 is greater than 1.5, diagonal length Lx in the x-axis direction is excessively less than diagonal length Ly in the y-axis direction. Accordingly, since a space in discharge cell 17 is excessively reduced, it is difficult to obtain a suitable luminance.

In addition, side surfaces 15 of barrier ribs 16 and inner surface 14 of dielectric layer 13 within discharge cell 17, are coated with a florescent paste, which is dried, exposed to light, developed, and annealed to form phosphor layers 19.

Alternatively, phosphor layers 19 may be formed by selectively applying a photosensitive paste method using the aforementioned photosensitive paste, a pattern printing method using a phosphor paste, and a dry film method using a phosphor sheet.

Phosphor layers 19 are made from the same color phosphor material in discharge cells 17 which are arranged along the y-axis direction. In addition, phosphor layers 19 are repeatedly made from red, green, and blue phosphor materials in the discharge cells which are disposed along the x-axis direction.

On the other hand, sustain and scan electrodes 31 and 32 which are disposed on inner surface 22 of front substrate 20 have a surface discharge structure corresponding to each discharge cell 17 so as to generate gas discharge in discharge cells 17. Sustain and scan electrodes 31 and 32 extend in the x-axis direction that crosses address electrodes 11.

For example, sustain electrodes 31 include transparent electrodes 31a and bus electrodes 31b which apply a voltage signal to transparent electrodes 31a. Scan electrodes 32 include transparent electrodes 32a and bus electrodes 32b which apply a voltage signal to transparent electrodes 32a. Transparent electrodes 31a and 32a are made from a transparent material (for example, indium tin oxide (ITO)) so as to maintain an aperture ratio of discharge cells 17 with respect to the portions where a surface discharge is carried out in discharge cells 17. Bus electrodes 31b and 32b are made from a metal having high electrical conductivity so as to compensate for high electric resistance of transparent electrodes 31a and 32a.

Transparent electrodes 31a and 32a have widths W31 and W32 along the direction from the outside of discharge cell 17 toward the center of discharge cell 17 to form a surface discharge structure. A discharge gap G is formed at the center of discharge cell 17. Bus electrodes 31b and 32b are disposed on transparent electrodes 31a and 32a. Bus electrodes 31b and 32b extend in the x-axis direction and are disposed at outer sides of discharge cells 17. Accordingly, when the voltage signal is applied to bus electrodes 31b and 32b, the voltage signal is transferred to transparent electrodes 31a and 32a electrically connected to bus electrodes 31b and 32b.

Returning to FIG. 1, sustain and scan electrodes 31 and 32, that cross address electrodes 11 and correspond to discharge cells 17, are covered with a dielectric layer 41. Dielectric layer 41 protects sustain and scan electrodes 31 and 32 against gas discharge. The wall charges are generated and accumulated in the dielectric layer when the discharge is carried out.

On the other hand, dielectric layer 41 is covered with a passivation layer 42. For example, passivation layer 42 is made from transparent magnesium oxide (MgO) which protects dielectric layer 40 to increase a secondary electron emission coefficient when the discharge is carried out.

When the plasma display panel according to an embodiment of the present invention is driven, a reset discharge is carried out by a reset pulse applied to scan electrodes 32 during a reset period, an address discharge is carried out by a scan pulse applied to scan electrodes 32 and an address pulse applied to address electrodes 11 during an address period subsequent to the reset period, and then a sustain discharge is carried out by a sustain pulse applied to sustain and scan electrodes 31 and 32 during a sustain period.

Sustain and scan electrodes 31 and 32 have a function of applying the sustain pulse for the sustain discharge. Scan electrodes 32 have a function of applying the reset pulse and the scan pulse. Address electrodes 11 have a function of applying the address pulse. Since the functions of sustain, scan, and address electrodes 31, 32, and 11 may be changed according to voltage waveforms applied to sustain, scan, and address electrodes 31, 32, and 11, the functions of sustain, scan, and address electrodes 31, 32, and 11 are not limited to the aforementioned functions.

The plasma display panel according to an embodiment of the principles of the present invention selects discharge cells 17 to turn on by using the address discharge due to the interactions between address and scan electrodes 11 and 32 and drives the selected discharge cells 17 by using the sustain discharge due to the interactions between sustain and scan electrodes 31 and 32 to display images.

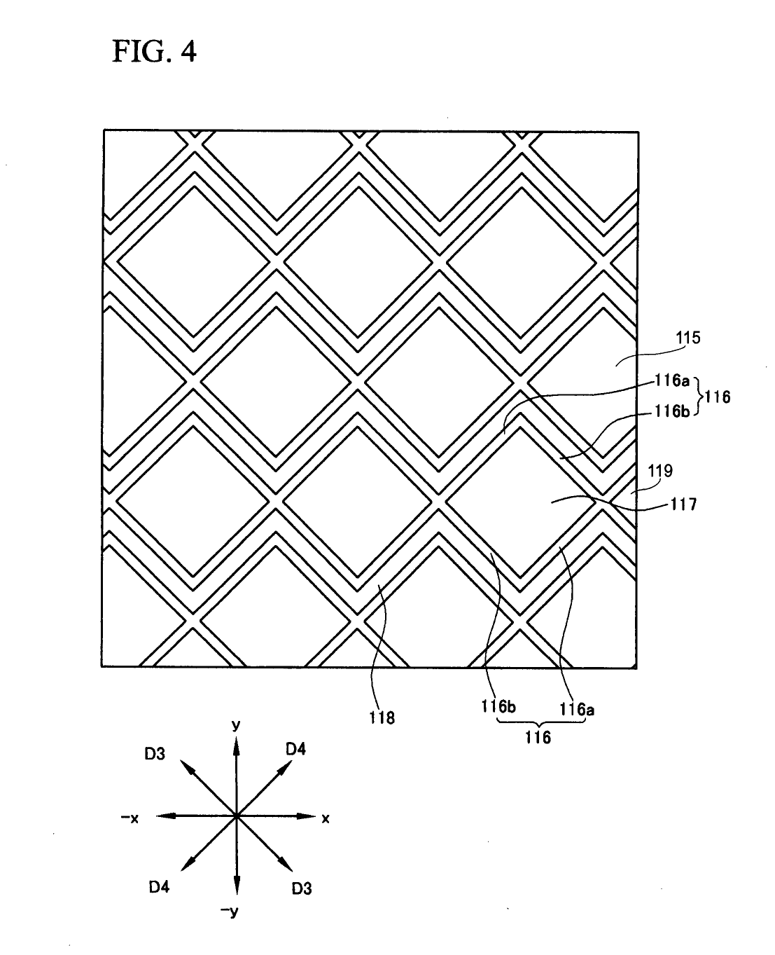

FIG. 4 is a top plan view illustrating an arrangement of barrier ribs and discharge cells according to a second embodiment of the principles of the present invention.

Since the arrangement structure of the barrier ribs and the discharge cells according to the second embodiment of the present invention is similar to that of FIG. 3 according to the first embodiment of the present invention, the arrangement structure according to the second embodiment will be described in comparison with the arrangement structure according to the first embodiment.

Barrier ribs 16 of the plasma display panel according to the first embodiment of the present invention define separate discharge cells 17 in x-axis and y-axis directions. Exhaust paths 18 are formed in third and fourth directions D3 and D4 so as to improve exhaust performance.

On the other hand, barrier ribs 116 of the plasma display panel according to the second embodiment of the present invention form exhaust paths 118 by defining discharge cells 117 so that the discharge cells disposed along the x-axis direction are not spaced apart from one another and the discharge cells disposed along the y-axis direction are spaced apart from one another. For example, discharge cells 117 and 119 are not spaced apart from each other since the barrier ribs of discharge cells 117 and 119 are connected. On the other hand, discharge cells 115 and 119 are spaced apart from each other since there is a gap between the barrier ribs of each of the discharge cells.

According to the second embodiment of the present invention, since exhaust paths 118 are connected along the x-axis direction and are not connected along the y-axis direction, it is possible to improve a degree of integration of discharge cells 117 in the x-axis direction.

More specifically, barrier ribs 116 include a pair of first barrier ribs 116a and a pair of second barrier ribs 116b. The pair of first barrier ribs 116a and the pair of second barrier ribs 116b defines a single discharge cell 117 in a rhombic shape. Discharge cells 117 that are disposed along the x-axis direction are not spaced apart from one another. In other words, discharge cells 117 are not spaced apart from one another along the x-axis direction such that there is no exhaust path formed between discharge cells 17 disposed along the x-axis direction. Discharge cells 117 that are disposed along the y-axis direction are spaced apart from one another in the y-axis direction. Therefore, exhaust paths 118 are formed in the x-axis direction.

Exhaust paths 118 which are formed in the x-axis direction have a zigzag shape alternately along third and fourth directions D3 and D4.

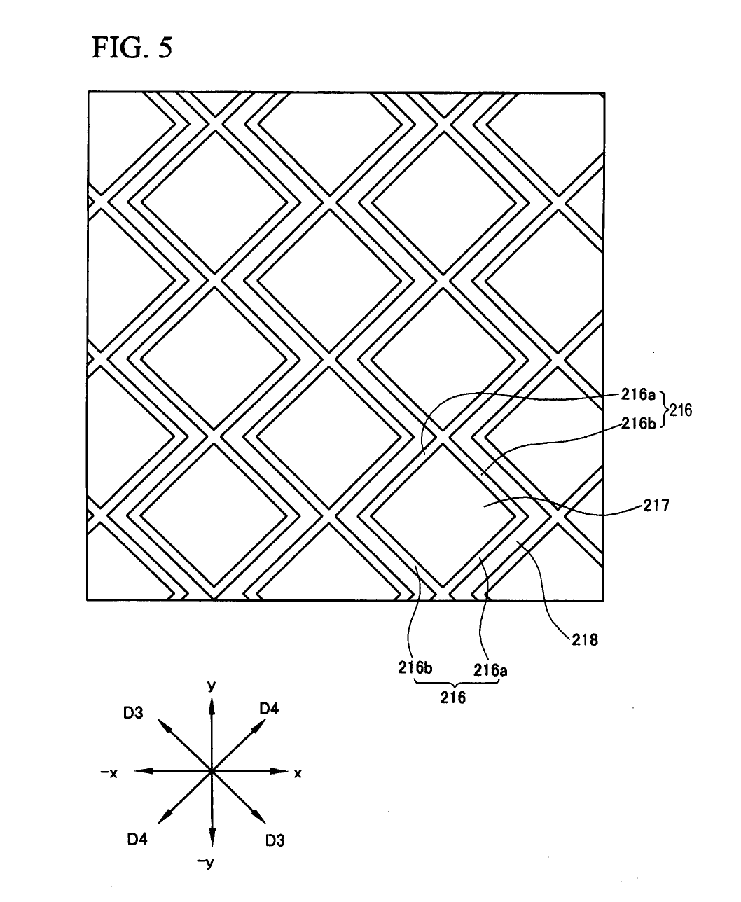

FIG. 5 is a top plan view illustrating an arrangement of barrier ribs and discharge cells according to a third embodiment of the principles of the present invention.

Since an arrangement structure of barrier ribs and discharge cells of the plasma display panel according to the third embodiment of the present invention is similar to that of FIG. 3 according to the first embodiment of the present invention, the arrangement structure according to the third embodiment will be described in comparison with the arrangement structure according to the first embodiment.

Barrier ribs 16 of the plasma display panel according to the first embodiment of the present invention define separate discharge cells 17 in x-axis and y-axis directions. Exhaust paths 18 are formed in third and fourth directions D3 and D4 so as to improve exhaust performance.

On the other hand, barrier ribs 216 of the plasma display panel according to the third embodiment of the present invention form exhaust paths 218 by defining discharge cells 217 so that the discharge cells that are disposed along the y-axis direction are not spaced apart from one another, and the discharge cells that are disposed along the x-axis direction are spaced apart from one another.

According to the third embodiment of the present invention, since exhaust paths 218 are connected along the y-axis direction and are not connected along the x-axis direction, it is possible to improve a degree of integration of discharge cells 217 in the y-axis direction.

More specifically, barrier ribs 216 include a pair of first barrier ribs 216a and a pair of second barrier ribs 216b. The pair of first barrier ribs 216a and the pair of second barrier ribs 216b defines a single discharge cell 217 in a rhombic shape. Discharge cells 217 that are disposed along the y-axis direction are not spaced apart from one another. In other words, there is no space between discharge cells 217 disposed along the y-axis direction. Discharge cells 217 that are disposed along the x-axis direction are spaced apart from one another in the x-axis direction. Therefore, exhaust paths 218 are formed in the y-axis direction.

Exhaust paths 218 which are formed in the y-axis direction have a zigzag shape alternately along third and fourth directions D3 and D4.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display panel, comprising:
a first substrate;
a second substrate facing the first substrate;
barrier ribs disposed between the first and second substrates to define discharge cells;
address electrodes extending in a first direction and corresponding to the discharge cells; and
first and second electrodes extending in a second direction that crosses the first direction and corresponding to the discharge cells,
with red, green, and blue discharge cells among the discharge cells being disposed in a triangular shape, and
with exhaust paths being formed between neighboring discharge cells.

2. The plasma display panel of claim 1, with the discharge cells having a rhombic shape with diagonals in the first and second directions.

3. The plasma display panel of claim 2, with the barrier ribs defining separate discharge cells that are spaced apart from one another along both the first and second directions.

4. The plasma display panel of claim 3, with the exhaust paths being formed in third and fourth directions, both of which cross the first and second directions.

5. The plasma display panel of claim 4, with the third direction being orthogonal to the fourth direction.

6. The plasma display panel of claim 2,
with the barrier ribs of the discharge cells that are disposed along the second direction being connected to one another, and
with the barrier ribs of the discharge cells that are disposed along the first direction being spaced apart from one another to form the exhaust paths between the barrier ribs.

7. The plasma display panel of claim 2,
with the barrier ribs of the discharge cells that are disposed along the first direction being connected to one another, and
with the barrier ribs of the discharge cells that are disposed along the second direction being spaced apart from one another to form the exhaust paths between the barrier ribs.

8. The plasma display panel of claim 2, with a ratio of a diagonal length of the discharge cell the first direction to a diagonal length of the discharge cell in the second direction ranging from approximately 1 to approximately 1.5.

9. The plasma display panel of claim 2, with a width of the barrier ribs being smaller than a width of the exhaust paths.

10. The plasma display panel of claim 2,
with the first and second electrodes being covered with a dielectric layer, and
with the dielectric layer and the barrier ribs being in a subtractive color mixture relation.

11. The plasma display panel of claim 10, with the dielectric layer and the barrier ribs being in a complementary color relation.

12. The plasma display panel of claim 11,
with the dielectric layer being colored with blue, and
with the barrier ribs being colored with red or brown.

13. The plasma display panel of claim 1, with the barrier ribs comprising:
a pair of first barrier ribs which extend in a third direction crossing the first and second directions and are spaced apart from one another with a distance corresponding to the length of each discharge cell along a fourth direction which is perpendicular to the third direction; and
a pair of second barrier ribs which extend in the fourth direction and are spaced apart from one another with a distance corresponding to the length of each discharge cell along the third direction.

14. The plasma display panel of claim 13, with the pair of the first barrier ribs and the pair of the second barrier ribs form discharge cells that have a rhombic shape and that are separated from one another along both the first and second directions.

15. The plasma display panel of claim 13,
with the pair of the first barrier ribs and the pair of the second barrier ribs of the discharge cells disposed along the second direction either being connected to each other or crossing each other,
with the pair of the first barrier ribs and the pair of the second barrier ribs of the discharge cells disposed along the first direction being spaced apart from each other to form the exhaust paths, and
with the discharge cells having a rhombic shape.

16. The plasma display panel of claim 15, with the exhaust paths having a zigzag shape along the third and fourth directions alternately.

17. The plasma display panel of claim 13,
with the pair of the first barrier ribs and the pair of the second barrier ribs of the discharge cells disposed along the first direction either being connected to each other or crossing each other,
with the pair of the first barrier ribs and the pair of the second barrier ribs of the discharge cells disposed along the second direction being spaced apart from each other to form the exhaust paths, and
with the discharge cells having a rhombic shape.

18. The plasma display panel of claim 17, with the exhaust paths having a zigzag shape along the third and fourth directions alternately.
